(19) United States
(12) Patent Application Publication
(10) Pub. No.: US 2007/0114929 A1
(43) Pub. Date: May 24, 2007

(54) Plasma display panel (PDP)

(76) Inventor: Seung-Hyun Son, Suwon-si (KR)

Correspondence Address: Robert E. Bushnell, Suite 300, 1522 K Street, N.W., Washington, DC, 20005-1202, US

(21) Appl. No.: 11/600,879

(22) Filed: Nov. 17, 2006

(30) Foreign Application Priority Data
Nov. 22, 2005 (KR) 10-2005-0111984

(51) Int. Cl. H01J 17/49

(52) U.S. Cl. 313/582; 313/586; 313/495

(57) ABSTRACT

A Plasma Display Panel (PDP) having a structure that improves the brightness and the efficiency of the PDP includes: a first substrate; a second substrate arranged to face the first substrate; barrier ribs arranged between the first and second substrates to define a plurality of discharge cells together with the first and second substrates; at least one first discharge electrode arranged on the first substrate; a first dielectric layer arranged on the first substrate to cover the at least one first discharge electrode; an Electroluminescent (EL) light-emitting layer arranged at least on a portion of at least one second discharge electrode; and a discharge gas contained within the plurality of discharge cells.

### CLAIM OF PRIORITY

This application makes reference to, incorporates the same herein, and claims all benefits accruing under 35 U.S.C.§119 from an application for PLASMA DISPLAY PANEL earlier filed in the Korean Intellectual Property Office on the 22^{nd} of Nov. 2005 and there duly assigned Serial No. 10-2005-0111984.

### BACKGROUND OF THE INVENTION

1. Field of the Invention

The present invention relates to a Plasma Display Panel (PDP), and more particularly, the present invention relates to an opposed discharge PDP including an Electroluminescent (EL) emitting layer.

2. Description of the Related Art

Recently, Plasma Display Panels (PDPs) have begun to be used as replacements for conventional Cathode Ray Tube (CRT) displays. In PDPs, a discharge gas is sealed inside two substrates on which a plurality of electrodes have been formed, and a discharge voltage is supplied to the electrodes to generate a plasma discharge to form a desired image.

Generally, the brightness and efficiency of a PDP are main factors that are considered when evaluating the capability of a PDP. One way to increase the brightness and efficiency is to increase a surface area of a phosphor layer. However, the brightness and efficiency of the PDP can only be increased by a limited amount by increasing the surface area of the PDP.

Another way to increase the brightness of the PDP is to increase a discharge voltage supplied to the discharge electrodes. However, when the discharge voltage has reached a specific value, the brightness does not increase or the increase ratio of the brightness decreases, and accordingly, the efficiency of the PDP is reduced.

Recently, since more fine pitch PDPs are being manufactured, the size of the discharge cells becomes small and the surface area of the phosphor layer coated in the discharge cells becomes small as well. Thus, the amount of visible light generated by each discharge cell decreases, thereby reducing the efficiency of the PDP.

Accordingly, a new structure to increase the brightness and efficiency of PDPs is required.

### SUMMARY OF THE INVENTION

The present invention provides a Plasma Display Panel (PDP) having a structure that increases the brightness and efficiency of the PDP.

According to one aspect of the present invention, a Plasma Display Panel (PDP) is provided including: a first substrate; a second substrate arranged to face the first substrate; barrier ribs arranged between the first and second substrates, the barrier ribs defining a plurality of discharge cells together with the first and second substrates; at least one first discharge electrode arranged on the first substrate; a first dielectric layer arranged on the first substrate to cover the at least one first discharge electrode; at least one second discharge electrode arranged on the second substrate; an Electroluminescent (EL) light-emitting layer arranged on at least a portion of the at least one second discharge electrode; and a discharge gas contained within the plurality discharge cells.

The EL light-emitting layer preferably includes a material selected from a group consisting of an inorganic EL light-emitting material and quantum dots. The EL light-emitting layer preferably has a thickness in a range of 500 to 5000 Å, upon the EL light-emitting layer being the inorganic light-emitting material. The EL light-emitting layer preferably emits light in response to a discharge voltage being supplied to the at least one first discharge electrode and the at least one second discharge electrode.

The inorganic EL light-emitting material preferably includes a material selected from a group consisting of ZnS:Mn, ZnS:Tb, SrS:Ce, Ca₂S₄:Ce, SrS:Cu, Ag, CaS:Pb and BaAl₂S₄:Eu.

Each of the quantum dots preferably includes a core of CdSe, a cell of ZnS arranged to surround the core, and caps of Trioctylphosphine Oxide (TOPO) arranged on an outer surface of the cell.

The PDP preferably further includes a dielectric layer arranged to bury the at least one second discharge electrode upon the EL light-emitting layer not burying the entire at least one second discharge electrode, the at least one second discharge electrode being exposed to a discharge space of the plurality of discharge cells. The PDP preferably further includes a dielectric layer arranged between the at least one second discharge electrode and the EL light-emitting layer.

The PDP preferably further includes a phosphor layer arranged within the plurality of discharge cells. The phosphor layer preferably includes a material selected from a group consisting of a photoluminescent phosphor material and quantum dots.

The PDP preferably further includes a protective layer arranged within the plurality of discharge cells.

According to another aspect of the present invention, a Plasma Display Panel (PDP) is provided including: a first substrate; a second substrate arranged to face the first substrate; barrier ribs arranged between the first and second substrates to define a plurality of discharge cells together with the first and second substrates; at least one first discharge electrode arranged on the first substrate; a first Electroluminescent (EL) light-emitting layer arranged at least on a portion of the at least one first discharge electrode; at least one second discharge electrode arranged on the second substrate; a second EL light-emitting layer arranged at least on a portion of the at least one second discharge electrode; a discharge gas contained within the plurality of discharge cells.

The first EL light emitting layer preferably includes a material selected from a group consisting of an inorganic EL light-emitting material and quantum dots. The first EL light-emitting layer preferably has a thickness in a range of 500 to 5000 Å upon the first EL light-emitting layer being the inorganic light emitting material. The first EL light-emitting layer and the second EL light-emitting layer preferably emit light in response to a discharge voltage supplied to the at least one first discharge electrode and at least one the second discharge electrode.

The inorganic EL light-emitting material is preferably a material selected from a group consisting of ZnS:Mn, ZnS:Tb, SrS:Ce, Ca₂S₄:Ce, SrS:Cu, Ag, CaS:Pb and BaAl₂S₄:Eu.

Each of the quantum dots preferably includes a core CdSe, a cell of ZnS arranged to surround the core, and caps of Trioctylphosphine Oxide (TOPO) arranged on an outer surface of the cell.

The second EL light-emitting layer preferably includes a material selected a group consisting of an inorganic light EL light emitting material and quantum dots. The second EL light-emitting layer preferably has a thickness in a range of 500 to 5000 Å upon the second EL light-emitting layer being the inorganic light emitting material.

The first EL light-emitting layer and the second EL light-emitting layer preferably emit light in response to a discharge voltage supplied to the at least one first discharge electrode and the at least one second discharge electrode.

The inorganic EL light-emitting material is preferably a material selected from a group consisting of ZnS:Mn, ZnS:Tb, SrS:Ce, Ca₂S₄:Ce, SrS:Cu, Ag, CaS:Pb and BaAl₂S₄:Eu.

Each of the quantum dots preferably include a core of CdSe, a cell of ZnS arranged to surround the core, and caps of Trioctylphosphine Oxide (TOPO) arranged on an outer surface of the cell.

The PDP preferably further includes a dielectric layer arranged to bury the at least one first discharge electrode upon the first EL light-emitting layer not burying the entire at least one first discharge electrode, the at least one first discharge electrode being exposed to a discharge space of the plurality of discharge cells. The PDP preferably further includes a dielectric layer arranged to bury the at least one second discharge electrode upon the second EL light-emitting layer not burying the entire at least one second discharge electrode, the at least one second discharge electrode being exposed to a discharge space of the plurality of discharge cells. The PDP preferably further includes a dielectric layer arranged between the at least one first discharge electrode and the first EL light-emitting layer. The PDP preferably further includes a dielectric layer arranged between the at least one second discharge electrode and the second EL light-emitting layer.

The PDP preferably further includes a phosphor layer arranged within the plurality of discharge cells. The phosphor layer preferably includes a material selected from a group consisting of a photoluminescent phosphor material and quantum dots.

The PDP preferably further includes a protective layer arranged within the discharge cells.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a Plasma Display Panel (PDP) according to an embodiment of the present invention;

FIG. 2 is a cross-sectional view of the PDP of FIG. 1 taken along a line II-II′ according to an embodiment of the present invention;

FIG. 3 is a cross-sectional view of a PDP according to another embodiment of the present invention;

FIG. 4 is an exploded perspective view of a PDP according to another embodiment of the present invention;

FIG. 5 is a cross-sectional view of the PDP of FIG. 4 taken along a line V-V′; and

FIG. 6 is a cross-sectional view of quantum dots included in the PDP of FIG. 4.

### DETAILED DESCRIPTION OF THE INVENTION

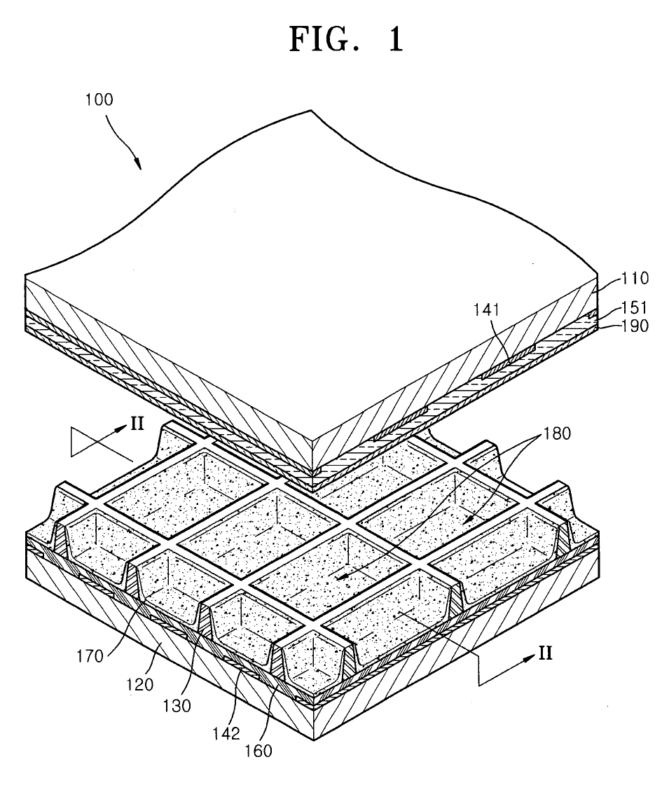

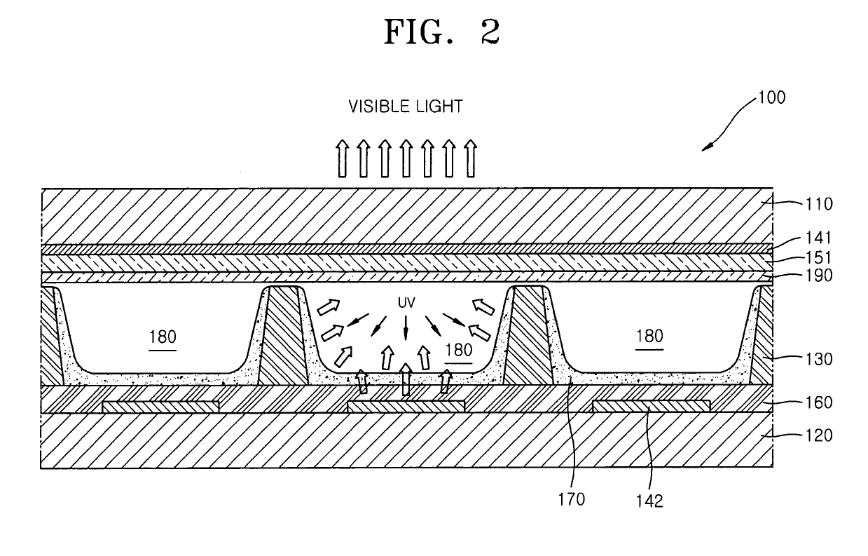

FIG. 1 is an exploded perspective view of a plasma display panel (PDP) 100 according to an embodiment of the present invention; and FIG. 2 is a cross-sectional view of the PDP of FIG. 1 taken along a line II-II′ according to an embodiment of the present invention.

Referring to FIGS. 1 and 2, the PDP 100 includes a first substrate 110, a second substrate 120, barrier ribs 130, a first discharge electrode 141, a second discharge electrode 142, a first dielectric layer 151, an Electroluminescent (EL) light emitting layer 160, a phosphor layer 170, and a discharge gas.

The first substrate 110 and the second substrate 120 are separated from each other and are arranged to face each other. The first substrate 110 is transparent to visible light.

Since the first substrate is transparent, visible light generated by a discharge is transmitted through the first substrate 110. However, the present invention is not limited thereto. That is, the first substrate can be opaque and the second substrate transparent or both the first substrate and the second substrate can be transparent. Also, the first substrate and the second substrate can be semitransparent and a color filter can be formed on a surface of the first and second substrates or inside the first and second substrates.

At least one barrier rib 130 is formed between the first substrate 110 and the second substrate 120. The barrier ribs 130 are formed in a non-discharge area and define discharge cells 180 together with the first substrate 110 and the second substrate 120 and prevents crosstalk of charged particles.

The first discharge electrode 141 is formed of ITO. However, the present invention is not limited thereto. That is, the first discharge electrode can be formed of Ag, Cu, or Al, which are not transparent. However, if the first discharge electrode 141 is not transparent, the first discharge electrode 141 is divided into several narrow stripes to increase the transmittance of the visible light so that the light can be transmitted between the stripes.

The first discharge electrode 141 of the present embodiment does not include a supplementary electrode to reduce line resistance. However, it is not limited thereto. That is, the first discharge electrode 141 can include a bus electrode formed of a material having a high electrical conductivity, such as Ag, to reduce line resistance.

The first dielectric layer 151 is disposed on the first substrate 110 to cover and bury the first discharge electrode 141. The first dielectric layer 151 prevents direct collision of the charged particles with the first discharge electrode 141 during dielectric discharge and accumulates wall discharge by inducing charged particles. The dielectric material can be PbO, B₂O₃, or SiO₂.

A protective layer 190 is formed on a rear surface of the first dielectric layer 151 and is formed of oxide magnesium (MgO). The protective layer 190 prevents the first discharge electrode 141 and the first dielectric layer 151 from being damaged by sputtering of plasma particles and generates secondary electrons to reduce the discharge voltage. The second discharge electrode 142 is arranged in stripes to cross the extending direction of the first discharge electrode 141 and is formed of Ag, Cu, or Al. The second discharge electrode 142 of the present embodiment is formed of Ag, Cu, or Al, which are not transparent. However, the material is not limited thereto. That is, the second discharge electrode 142 can be a transparent electrode formed of ITO.

The EL light-emitting layer 160 is formed on the second substrate 120 to cover and bury the second discharge electrode 142. The EL light-emitting layer 160 is formed of an inorganic EL light emitting material, such as ZnS:Mn, ZnS:Tb, SrS:Ce, Ca₂S₄:Ce, SrS:Cu, Ag, CaS:Pb, BaAl₂S₄:Eu.

Generally, when voltages of opposite polarities are supplied to opposite sides of an inorganic EL light emitting material, a current flows through the inorganic EL light-emitting material and an electron transition occurs in the inorganic EL light-emitting material to generate light. Since a discharge sustain voltage of the PDP 100 is in the range of 150 V to 190 V, the inorganic EL light emitting materials used in the present embodiment can be inorganic EL light emitting materials which emit light in the range of the discharge sustain voltage of the PDP. Thus, ZnS:Mn type or ZnS:Tb type inorganic EL light emitting materials having a brightness of 4000 to 5000 cd/m² can be used.

The thickness of the EL light-emitting layer 160 can be in the range of 500 to 5000 A. When the thickness of the EL light-emitting layer 160 is greater than 5000 Å, the light transmittance is degraded and when the thickness of the EL light emitting layer 160 is less than 500 Å, insufficient light is generated in the inorganic El light-emitting materials.

The EL light emitting layer 160 of the present embodiment covers and buries the second discharge electrode 142. However, the present invention is not limited thereto. That is, the EL light emitting layer 160 can cover and bury only a portion of the second discharge electrode 142. However, in this case, the second discharge electrode is exposed to a discharge space defined by the discharge cells 180 and this direct exposure can cause the second discharge electrode 142 to be damaged by the discharge, and thus, a dielectric layer can be additionally formed to bury the second discharge electrode 142.

The EL light emitting layer 160 of the present embodiment is formed of an inorganic EL light emitting material. However, the material is not limited thereto. That is, the EL light emitting layer can be formed of a material including quantum dots.

In the present embodiment, the second discharge electrode 142 and the EL light emitting layer 160 are formed very close to each other and no layer is interposed therebetween. However, the present invention is not limited thereto. That is, as occasion demands, a dielectric layer can be formed between the second discharge electrode 142 and the EL light emitting layer 160.

The above described barrier ribs 130 are formed on the EL light emitting layer 160. The barrier ribs 130 can be formed using a sandblasting method or a printing method. The barrier ribs 130 can be also formed by forming sheets out of barrier ribs materials and boring holes in these sheets to define discharge cells.

As illustrated in FIG. 1, according to the current embodiment of the present invention, the cross-section of the discharge cells 180 is a square. However, their shape is not limited thereto. That is, the cross-section of each of the discharge cells 180 can be polygonal, such as a triangle, a pentagon, a circle or an oval and the barrier ribs 130 can be formed in a stripe pattern such that each of the discharge cells 180 are open.

A phosphor layer 170 is formed in the discharge cells 180 defined by the barrier ribs 130. The phosphor layer 170 is formed on a side surface of the barrier ribs 130 and on a surface of the EL light emitting layer 160. However, the present invention is not limited thereto. That is, if the PDP of the present invention includes a phosphor layer, the phosphor layer can be formed anywhere in the discharge cells of the PDP.

The phosphor layer 170 has a photoluminescent phosphor material element generating visible light by receiving ultraviolet rays. Red, green, and blue color phosphor layers according to the colors of visible light are formed. Red color emitting phosphor layers formed in red discharge cells include a phosphor material, such as Y (V, P) O₄:Eu, green color emitting phosphor layers formed in green discharge cells include a phosphor material such, as Zn₂SiO₄:Mn, and blue color emitting phosphor layers formed in blue discharge cells include a phosphor material, such as BaMgAl₁₀O₁₇:Eu.

The phosphor layer 170 of the present embodiment is formed of a photoluminescent phosphor material. However, the present invention is not limited thereto. That is, the phosphor layer 170 can also be formed of a material including quantum dots.

In the present embodiment, the phosphor layer 170 is formed in the discharge cells 180; however, the present invention is not limited thereto. That is, the PDP of the present invention may not include a phosphor layer in the discharge cells and in this case, only the EL light emitting layer emits light and a plasma discharge contributes to light being emitted from the EL light-emitting layer.

As described above, after the barrier ribs 130, the first discharge electrode 141, the second discharge electrode 142, the first dielectric layer 151, the EL light emitting layer 160, and the phosphor layer 170 are formed between the first substrate 110 and the second substrate 120, the first substrate 110 and the second substrate 120 are sealed using a material such as a frit.

After the first substrate 110 and the second substrate 120 are sealed, since the inner space of the assembled PDP 100 is filled with air, the air in the assembled PDP 100 is completely discharged and replaced with an adequate discharge gas that can improve the discharge efficiency.

The discharge gas can be a mixed gas, such as Ne—Xe or He—Ne—Xe including Xe. The discharge gas can also include N₂, D₂, CO₂, H₂, CO, Ne, He, Ar, air at atmospheric pressure, and Kr.

Hereinafter is a description of an example of the discharge process of the PDP 100 according to an embodiment of the present invention.

First, when a discharge voltage is supplied from an external power source to the first discharge electrode 141 and the second discharge electrode 142 of the discharge cells 180 in which discharge is to be generated, wall charges are accumulated between the first dielectric layer 151 and the EL light-emitting layer 160. The accumulated wall charges move due to an AC discharge voltage and thus generate an opposed plasma discharge. Accordingly, the energy level of the discharge gas of in the discharge cells 180 is decreased and ultraviolet rays are radiated.

The radiated ultraviolet rays excite the phosphor materials of the phosphor layer 170 and the energy level of the excited phosphor materials is decreased and red, green, and blue visible light is emitted.

The EL light-emitting layer 160 is disposed on the plasma discharge path and current flows through the EL light-emitting layer 160 during a discharge. This is because the discharge voltage supplied to the first discharge electrode 141 and the second discharge electrode 142 is an Alternating Current (AC) voltage, and the voltage is supplied to each end of the EL light-emitting layer 160 functioning as a dielectric and current flows therethrough. When a current flows through the EL light-emitting layer 160, visible light is emitted by an electron transition or a tunnel effect.

The visible light emitted from the phosphor layer 170 and the EL light-emitting layer 160 is combined and radiated through the first substrate 110 to the outside, and thus, the PDP 100 realizes an image.

The PDP 100 according to the present embodiment includes an inorganic EL light-emitting material so that the visible light emitted from the inorganic EL light-emitting material and the visible light emitted from the phosphor layer 170 are combined and radiated, thus being brighter than conventional PDPs.

In addition, the PDP 100 does not require additional power to drive the EL light-emitting layer 160 and only the discharge voltage needs to be supplied to the first discharge electrode 141 and the second discharge electrode 142. Thus, the power consumed is not increased and the luminous efficiency is high.

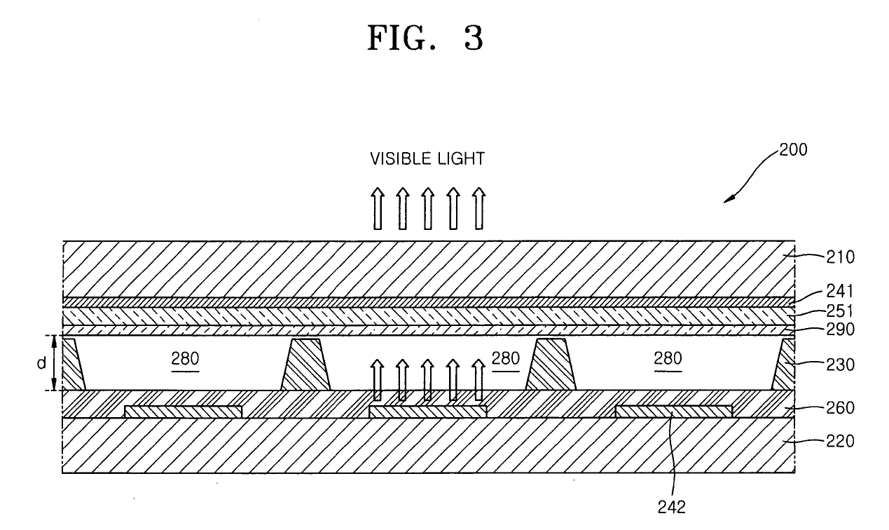

Hereinafter, another example of the PDP of FIG. 1 is described with reference to FIG. 3. FIG. 3 is a cross-sectional view of a PDP 200 according to another embodiment of the present invention. Descriptions of components common to the present embodiment and the previous embodiment have not been repeated.

Referring to FIG. 3, the PDP 200 includes a first substrate 210, a second substrate 220, barrier ribs 230, a first discharge electrode 241, a second discharge electrode 242, a first dielectric layer 251, an EL light-emitting layer 260 formed of an inorganic El light-emitting material, a protective layer 290, and a discharge gas.

One of the main features distinguishing the PDP 200 of FIG. 3 from the PDP 100 of FIG. 1 is that the PDP 200 does not include a phosphor layer. That is, since the PDP 200 does not include a phosphor layer, only the EL light-emitting layer 260 emits visible light.

The plasma discharge functions mainly as a controlling switch of the light emitting of the EL light-emitting layer 260 and the gap of the discharge gas area, that is, a distance d between the protective layer 290 and the EL light-emitting layer 260 can be 30 μm or less. This is because the smaller the distance d between the protective layer 290 and the EL light-emitting layer 260, the shorter the plasma discharge path, and thus, the current flowing through the EL light-emitting layer 260 can be controlled promptly and the light emitting of the EL light-emitting layer 260 can be easily controlled.

The characteristics of the PDP 200 are as follows.

When a discharge voltage is supplied from an external power source to the first discharge electrode 241 and the second discharge electrode 242 to generate a plasma discharge, a current flows through the EL light-emitting layer 260 and visible light is emitted. When a plasma discharge is not generated, no current flows through the EL light-emitting layer 260 and no visible light is emitted.

The plasma discharge supplies current to the EL light-emitting layer 260 to control the light emitting of the EL light-emitting layer 260 and the ultraviolet rays generated due to the plasma discharge are not converted into visible light. Accordingly, in the present embodiment, ultraviolet rays are not used and the PDP 200 can be driven using only Ne as a discharge gas.

The PDP 200 does not require phosphor materials and has a simple structure, thereby reducing the manufacturing costs. Also, the height of the barrier ribs 230 can be reduced significantly and a very thin display can be realized.

Also, since the PDP 200 includes inorganic EL light-emitting materials as a light emitting source, the PDP 200 has the advantages of inorganic EL displays and also the memory characteristics and color gradation realization driving method of conventional PDPs.

As the structure, operation, and effect of the PDP 200 other than described herein are the same as the structure, operation, and effect of the PDP 100 of FIG. 1, descriptions thereof have not been repeated.

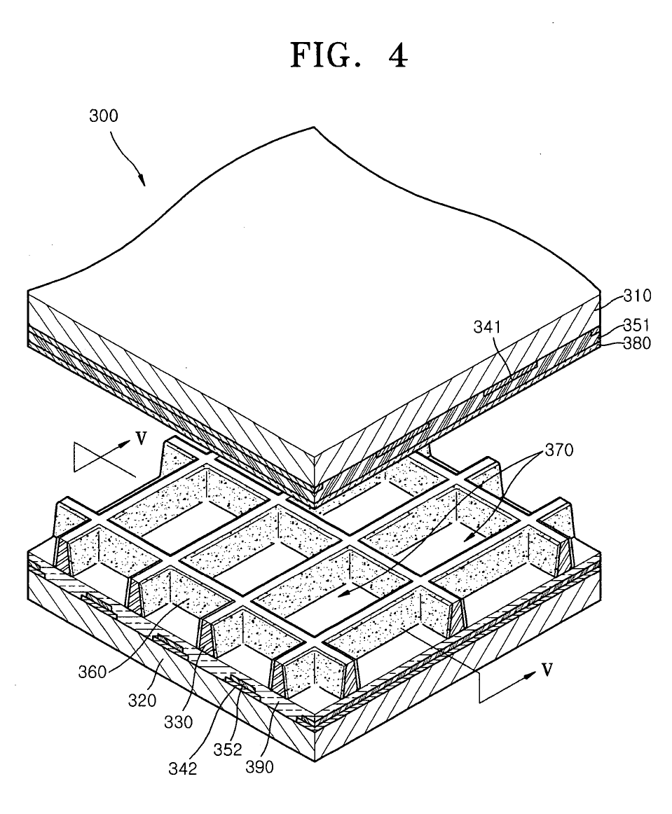

Hereinafter, a PDP according to another embodiment of the present invention is described with reference to FIGS. 4 through 6.

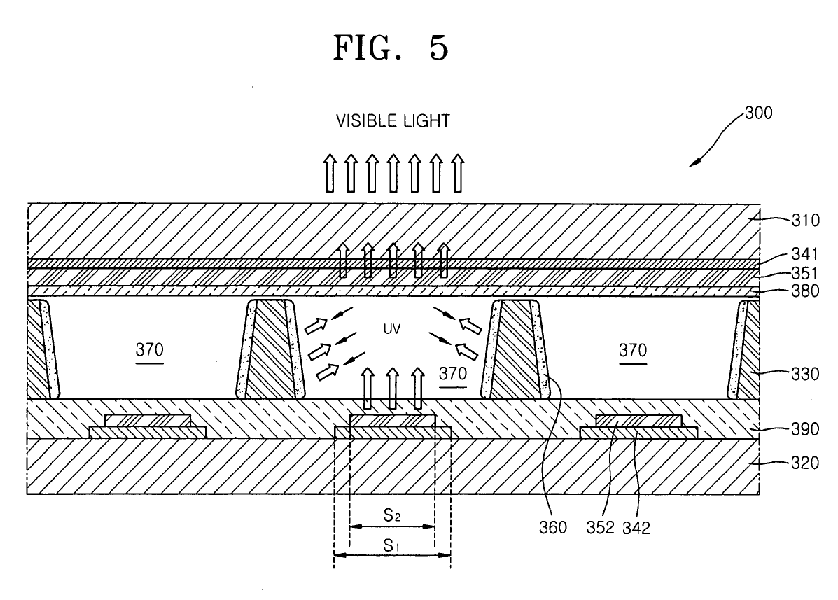

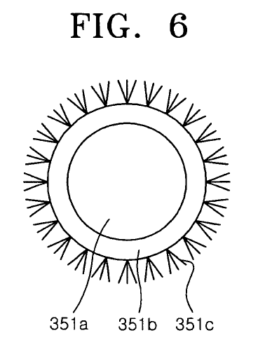

FIG. 4 is an exploded perspective view of a PDP 300 according to another embodiment of the present invention; FIG. 5 is a cross-sectional view of the PDP 300 of FIG. 4 taken along a line V-V′; and FIG. 6 is a cross-sectional view of quantum dots included in the PDP 300 of FIG. 4.

Referring to FIGS. 4 and 5, the PDP 300 includes a first substrate 310, a second substrate 320, barrier ribs 330, a first discharge electrode 341, a second discharge electrode 342, a first EL light-emitting layer 351, a second EL light-emitting layer 352, a phosphor layer 360, a dielectric layer 390, and a discharge gas.

The first substrate 310 and the second substrate 320 are separated from each other and face each other. The first substrate 310 is formed of a transparent glass to transmit visible light.

At least one barrier rib 330 is formed between the first substrate 310 and the second substrate 320. The barrier ribs 330 define the discharge cells 370 together with the first substrate 310 and the second substrate 320.

The first discharge electrode 341 is formed on a rear surface of the first substrate 310 in a stripe pattern and is a transparent electrode formed of ITO. The first EL light-emitting layer 351 is formed on the first substrate 310 to cover and bury the first discharge electrode 341. The first EL light-emitting layer 351 is formed of quantum dots. The quantum dots have a quantum efficiency of up to 100% and can be excited at a low voltage to increase the quantum efficiency. The quantum dots can be formed using a printing method that can be applied to large displays.

The quantum dots are formed of a core 351a of CdSe, a cell 351b of ZnS surrounding the core 351a, and caps 351c of trioctylphosphine oxide (TOPO) disposed on an outer surface of the cell 351b.

The first EL light-emitting layer 351 can be formed as a single layer or a multi-layer structure. Generally, luminous efficiency is better when the first EL light-emitting layer 351 is a single layer. A protective layer 380 is formed on a rear surface of the first EL light-emitting layer 351. The protective layer 380 is formed of MgO.

The protective layer 380 prevents the first discharge electrode 341 and the first EL light emitting layer 351 from being damaged by sputtering of plasma particles and reduces the discharge voltage by emitting second electrons. The second discharge electrode 342 is arranged to cross the first discharge electrode 341 and is formed in stripes on an upper surface of the second substrate 320.

The second discharge electrode 342 is a transparent electrode formed of ITO like the first discharge electrode 341.

The second EL light-emitting layer 352 is formed of the quantum dots used for the first EL light-emitting layer 351 and is disposed to cover a portion of the second discharge electrode 342. That is, the second EL light-emitting layer 352 does not bury the entire second discharge electrode 342. Thus, a width S2 of the second EL light-emitting layer 352 is less than a width S1 of the second discharge electrode 342.

Accordingly, as the second discharge electrode 342 can be damaged by being exposed to the discharge space of the discharge cells 370, the dielectric layer 390 is additionally disposed to bury the second discharge electrode 342.

The dielectric 390 can be formed of PbO, B₂O₃, or SiO₂ and covers not only the second discharge electrode 342 but also the second EL light-emitting layer 352.

In the present embodiment, the dielectric layer 390 covers both the second discharge electrode 342 and the second EL light emitting layer 352. However, the present invention is not limited thereto. That is, the purpose of forming a dielectric layer is to protect a second discharge electrode from being exposed to the discharge space of the discharge cells. Thus, if the second discharge electrode has a structure that is not exposed to the discharge space due to the forming of a dielectric layer, the second EL light emitting layer does not necessarily have to be covered by the dielectric layer.

In the present embodiment, the first discharge electrode 341 and the first EL light-emitting layer 351 are arranged close to each other and no layer is interposed therebetween. Also in the present embodiment, the second discharge electrode 342 and the second EL light-emitting layer 352 are arranged close to each other and no layer is interposed therebetween. However, the present invention is not limited thereto. That is, an additional dielectric layer can be further disposed between the first discharge electrode and the first EL light emitting layer or between the second discharge electrode and the second EL light emitting layer as occasions demand.

The above described barrier ribs 330 are formed on the dielectric layer 390 and the phosphor layer 360 is formed in the discharge cells 370 formed by the barrier ribs 330.

The phosphor layer 360 is formed on sides of the barrier ribs 330 to prevent degradation of the phosphor layer 360 due to the plasma discharge.

The phosphor layer 360 has a photoluminescent phosphor material element generating visible light by receiving ultraviolet rays. Red, green, and blue color phosphor layers are formed according to the colors of visible light.

The phosphor layer 360 includes the same phosphor materials as the phosphor layer 170 of FIG. 1 and thus a description thereof has not been repeated.

In the present embodiment, the phosphor layer 360 is formed in the discharge cells 180; however, the present invention is not limited thereto. That is, the PDP of the present invention can omit a phosphor layer in the discharge cells and in this case only the EL light emitting layer emits light and the plasma discharge causes the light emitting of the EL light-emitting layer.

As described above, after the barrier ribs 330, the first discharge electrode 341, the second discharge electrode 342, the EL light emitting layer 351, the second EL light emitting layer 352, and the phosphor layer 360 are formed between the first substrate 310 and the second substrate 320, the first substrate 310 and the second substrate 320 are sealed using a material, such as frit.

After the first substrate 310 and the second substrate 320 are sealed, since the inner space of the assembled PDP 300 is filled with air, the air in the assembled PDP 300 is completely discharged and replaced with an adequate discharge gas that can improve the discharge efficiency.

The discharge gas can be a mixed gas, such as Ne—Xe or He—Ne—Xe including Xe. The discharge gas can also include N₂, D₂, CO₂, H₂, CO, Ne, He, Ar, air at atmospheric pressure, and Kr.

Hereinafter, an example of the discharge process of the PDP 300 according to an embodiment of the present invention is described.

First, when a discharge voltage is supplied from an external power source to the first discharge electrode 341 and the second discharge electrode 342 of the discharge cells 180 in which discharge is to be generated, wall charges are accumulated between the EL light-emitting layer 351 and the dielectric layer 390 which are facing each other. The accumulated wall charges move due to an AC discharge voltage and generate a plasma discharge. Accordingly, the energy level of the discharge gas is decreased and ultraviolet rays are radiated.

The radiated ultraviolet rays excite the phosphor materials of the phosphor layer 360 disposed in the discharge cells 370 and the energy level of the excited phosphor materials is decreased and red, green, and blue visible light is emitted.

The first EL light-emitting layer 351 and the second EL light-emitting layer 352 are disposed on the plasma discharge path and current flows through the first EL light-emitting layer 351 and the second light-emitting layer 352 during the discharge. This is because the discharge voltage supplied to the first discharge electrode 341 and the second discharge electrode 342 is an AC voltage, and the voltage is supplied to each end of the first EL light-emitting layer 351 and the second EL light-emitting layer 352 functioning as dielectrics and a current flows therethrough. When a current flows through the first EL light-emitting layer 351 and the second EL light-emitting layer 352, visible light is emitted by an electron transition or a tunnel effect.

The visible light emitted from the phosphor layer 360, the first EL light-emitting layer 351 and the second EL light-emitting layer 352 is combined and radiated through the first substrate 310 to the outside and thus the PDP 300 realizes an image.

As described above, since the PDP 300 includes the first and second EL light-emitting layers 351 and 352 including quantum dots, the visible light emitted from the quantum dots and the visible light emitted from the phosphor layer 360 are combined and emitted. Accordingly, the brightness of the PDP 300 according to the current embodiment of the present invention is better than that of a conventional PDP.

Also, the PDP 300 requires no additional power for driving the first and second EL light-emitting layers 351 and 352 and just the existing discharge voltage needs to be supplied to the first discharge electrode 341 and the second discharge electrode 342. Thus, the power consumed does not increase and the luminous efficiency is high.

As described above, the PDP according to the present invention includes an EL light-emitting layer that emits light with the phosphor layer at the same time, thereby increasing the brightness of the PDP. Also, in a fine pitch panel, an improved brightness can be realized.

Also, no additional power to drive the EL light-emitting layer is required and just the existing discharge voltage during the sustain discharge needs to be supplied to the first discharge electrode and the second discharge electrode. Thus, no additional power is needed and the light efficiency of the PDP is improved.

Also, since the EL light-emitting layer operates only when a plasma discharge occurs in the discharging space of the discharge cells, improper emission does not occur.

Also, the PDP can omit a phosphor layer as occasion demands and in this case the structure is simple, thereby reducing the manufacturing costs. Also, the height of the barrier ribs can be reduced significantly, thus realizing very thin displays.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
a first substrate;
a second substrate arranged to face the first substrate;
barrier ribs arranged between the first and second substrates, the barrier ribs defining a plurality of discharge cells together with the first and second substrates;
at least one first discharge electrode arranged on the first substrate;
a first dielectric layer arranged on the first substrate to cover the at least one first discharge electrode;
at least one second discharge electrode arranged on the second substrate;
an Electroluminescent (EL) light-emitting layer arranged on at least a portion of the at least one second discharge electrode; and
a discharge gas contained within the plurality discharge cells.

2. The PDP of claim 1, wherein the EL light-emitting layer comprises a material selected from a group consisting of an inorganic EL light-emitting material and quantum dots.

3. The PDP of claim 2, wherein the EL light-emitting layer has a thickness in a range of 500 to 5000 Å, upon the EL light-emitting layer being the inorganic light-emitting material.

4. The PDP of claim 2, wherein the EL light-emitting layer emits light in response to a discharge voltage being supplied to the at least one first discharge electrode and the at least one second discharge electrode.

5. The PDP of claim 2, wherein the inorganic EL light-emitting material comprises a material selected from a group consisting of ZnS:Mn, ZnS:Tb, SrS:Ce, Ca₂S₄:Ce, SrS:Cu, Ag, CaS:Pb and BaAl₂S₄:Eu.

6. The PDP of claim 2, wherein each of the quantum dots comprises a core of CdSe, a cell of ZnS arranged to surround the core, and caps of Trioctylphosphine Oxide (TOPO) arranged on an outer surface of the cell.

7. The PDP of claim 1, further comprising a dielectric layer arranged to bury the at least one second discharge electrode upon the EL light-emitting layer not burying the entire at least one second discharge electrode, the at least one second discharge electrode being exposed to a discharge space of the plurality of discharge cells.

8. The PDP of claim 1, further comprising a dielectric layer arranged between the at least one second discharge electrode and the EL light-emitting layer.

9. The PDP of claim 1, further comprising a phosphor layer arranged within the plurality of discharge cells.

10. The PDP of claim 9, wherein the phosphor layer comprises a material selected from a group consisting of a photoluminescent phosphor material and quantum dots.

11. The PDP of claim 1, further comprising a protective layer arranged within the plurality of discharge cells.

12. A Plasma Display Panel (PDP), comprising:
a first substrate;
a second substrate arranged to face the first substrate;
barrier ribs arranged between the first and second substrates to define a plurality of discharge cells together with the first and second substrates;
at least one first discharge electrode arranged on the first substrate;
a first Electroluminescent (EL) light-emitting layer arranged at least on a portion of the at least one first discharge electrode;
at least one second discharge electrode arranged on the second substrate;
a second EL light-emitting layer arranged at least on a portion of the at least one second discharge electrode;
a discharge gas contained within the plurality of discharge cells.

13. The PDP of claim 12, wherein the first EL light emitting layer comprises a material selected from a group consisting of an inorganic EL light-emitting material and quantum dots.

14. The PDP of claim 13, wherein the first EL light-emitting layer has a thickness in a range of 500 to 5000 Å upon the first EL light-emitting layer being the inorganic light emitting material.

15. The PDP of claim 13, wherein the first EL light-emitting layer and the second EL light-emitting layer emit light in response to a discharge voltage supplied to the at least one first discharge electrode and at least one the second discharge electrode.

16. The PDP of claim 13, wherein the inorganic EL light-emitting material is a material selected from a group consisting of ZnS:Mn, ZnS:Tb, SrS:Ce, Ca₂S₄:Ce, SrS:Cu, Ag, CaS:Pb and BaAl₂S₄:Eu.

17. The PDP of claim 13, wherein each of the quantum dots comprises a core CdSe, a cell of ZnS arranged to surround the core, and caps of Trioctylphosphine Oxide (TOPO) arranged on an outer surface of the cell.

18. The PDP of claim 12, wherein the second EL light-emitting layer comprises a material selected a group consisting of an inorganic light EL light emitting material and quantum dots.

19. The PDP of claim 18, wherein the second EL light-emitting layer has a thickness in a range of 500 to 5000 Å upon the second EL light-emitting layer being the inorganic light emitting material.

20. The PDP of claim 18, wherein the first EL light-emitting layer and the second EL light-emitting layer emit light in response to a discharge voltage supplied to the at least one first discharge electrode and the at least one second discharge electrode.

21. The PDP of claim 18, wherein the inorganic EL light-emitting material is a material selected from a group consisting of ZnS:Mn, ZnS:Tb, SrS:Ce, Ca₂S₄:Ce, SrS:Cu, Ag, CaS:Pb and BaAl₂S₄:Eu.

22. The PDP of claim 18, wherein each of the quantum dots comprise a core of CdSe, a cell of ZnS arranged to surround the core, and caps of Trioctylphosphine Oxide (TOPO) arranged on an outer surface of the cell.

23. The PDP of claim 12, further comprising a dielectric layer arranged to bury the at least one first discharge electrode upon the first EL light-emitting layer not burying the entire at least one first discharge electrode, the at least one first discharge electrode being exposed to a discharge space of the plurality of discharge cells.

24. The PDP of claim 12, further comprising a dielectric layer arranged to bury the at least one second discharge electrode upon the second EL light-emitting layer not burying the entire at least one second discharge electrode, the at least one second discharge electrode being exposed to a discharge space of the plurality of discharge cells.

25. The PDP of claim 12, further comprising a dielectric layer arranged between the at least one first discharge electrode and the first EL light-emitting layer.

26. The PDP of claim 12, further comprising a dielectric layer arranged between the at least one second discharge electrode and the second EL light-emitting layer.

27. The PDP of claim 12, further comprising a phosphor layer arranged within the plurality of discharge cells.

28. The PDP of claim 27, wherein the phosphor layer comprises a material selected from a group consisting of a photoluminescent phosphor material and quantum dots.

29. The PDP of claim 12, further comprising a protective layer arranged within the discharge cells.
